(19) United States
(12) Patent Application Publication
(10) Pub. No.: US 2024/0308083 A1
(43) Pub. Date: Sep. 19, 2024

(54) CONTROL OF A TOOL MOUNTED ON A ROBOTIC ARM

(71) Applicant: VESTAS WIND SYSTEMS A/S, Aarhus N (DK)

(72) Inventor: Jeremy HAIGHT, Arvada, CO (US)

(21) Appl. No.: 18/571,698

(22) PCT Filed: Jun. 7, 2022
(86) PCT No.: PCT/DK2022/050121

§ 371 Date: Dec. 18, 2023

Related U.S. Application Data
(60) Provisional application No. 63/211,581, filed on Jun. 17, 2021.

(30) Foreign Application Priority Data
Aug. 18, 2021 (DK) PA202170415

(51) Int. Cl. B25J 9/16

(52) U.S. Cl. CPC B25J 9/1697; B25J 9/1664

(57) ABSTRACT

Controlling the position of a tool mounted on a robotic arm comprising projecting an image onto the workpiece from a projector and detected using a camera. The camera and projector are mounted on the tool or robotic arm. The image is used to determine a relative position of the tool with respect to a workpiece and the relative position is provided as an input to a controller which is configured to compare the relative position to a predetermined value. If the relative position is not equal to the predetermined value, a control signal is issued to a position controller to move the tool to a new position in which the relative position of the tool is closer to the predetermined value. Or, if the relative position is equal to the predetermined value, a control signal is issued to the position controller to maintain the tool in its current position.

### TECHNICAL FIELD

The present disclosure relates to a method of controlling a tool mounted on a robotic arm. In particular, the present disclosure relates to a method of controlling the position of a tool with respect to the relative position of the tool with respect to a workpiece.

### BACKGROUND

Modern horizontal axis wind turbines typically comprise a tower which supports a nacelle upon which a rotor is mounted. The rotor typically comprises a hub which supports three equally spaced blades. The blades are typically of an aerofoil shape designed to optimise efficiency and reduce drag.

Wind turbine blades are typically made from composite materials and can have spans (length from root to tip) in the region of 20 m to 80 m or more. The aerofoil shape of wind turbine blades results in highly complex blade geometry, with no similar cross-sectional shape existing from root to tip along the length of the blade.

Nearly all stages of the manufacturing process are completed manually by highly skilled technicians. The use of manual production methods in favour of automated production techniques is largely due to the difficulty of reliably and repeatably holding such large and complex blades in precisely the same position and orientation during each manufacturing process, something that is critical for automation which relies on fixed computer inputs and machine pathing to guide the automated systems. In addition, post-production processes, such as non-destructive ultrasound testing, require precise control of tool position and orientation in order to obtain reliable data.

It is against this background that the present invention has been developed.

### SUMMARY OF THE INVENTION

The present invention provides a method of controlling the position of a tool relative to a workpiece, wherein the tool is mounted on a robotic arm, and wherein the tool position is manipulable by a plurality of motors controlled by one or more motor controllers, the method comprising:
projecting an image onto the workpiece from a projector mounted on the tool or on the robotic arm, wherein the projected image comprises a line;
detecting the projected image using a camera mounted on the tool or on the robotic arm;
using the detected image to determine a relative position of the tool with respect to the workpiece; and
providing the determined relative position as an input to a relative position controller, wherein the relative position controller is configured to:
compare the determined relative position of the tool to a predetermined value, or to a range of predetermined values; and
if the determined relative position of the tool is not equal to the predetermined value, or is not within the range of predetermined values, issue a relative position control signal to a tool position controller, wherein the relative position control signal comprises an instruction to move the tool to a new position in which the relative position of the tool is closer to the predetermined value, or closer to the range of predetermined values; or
if the determined relative position of the tool is equal to the predetermined value, or is within the range of predetermined values, issue a relative position control signal to the tool position controller, wherein the relative position control signal comprises an instruction to maintain the tool in its current relative position,
wherein the tool position controller is configured to use the relative position control signal to determine a motor control signal, and wherein the tool position controller is configured is issue the motor control signal to the one or more motor controllers.

This method is advantageous as it ensures that the tool is correctly positioned with respect to the workpiece, something which is critical to ensure quality, repeatable, manufacturing processes.

Optionally the method may comprise:
providing a computer readable master pathing model;
using the master pathing model to generate a master control signal;
providing the master control signal as an input to the tool position controller, wherein the tool position controller is configured to:
use the master control signal and the relative position control signal to determine the motor control signal.

Combining the relative position control signal with the master control signal allows for a more efficient system which only has to fine tune its movement in relation to the master model.

Using the master control signal and the relative position control signal to determine the motor control signal optionally comprises a prioritised superposition of the master control signal and the relative position control signal.

Using the detected image to determine a relative position of the tool with respect to the workpiece may comprise determining a relative angular position between the tool and the workpiece, and wherein the step of issuing the relative position control signal comprises issuing a relative position control signal comprising an instruction to bring the relative angular position closer to the predetermined value, or to the range of predetermined values.

Precise control of the tool angle with respect to the workpiece helps to ensure optimum and correct use of the tool. This is particularly beneficial for tools requiring precise angular orientation with respect to the workpiece such as non-destructive testing equipment.

In one example, using the detected image to determine a relative angular position of the tool with respect to the workpiece comprises determining a tangent to the workpiece.

Optionally the relative position of the tool may be determined relative to a specific feature of the tool.

Using the detected image to determine the tangent to the workpiece optionally comprises determining the position of an apex of a portion of the surface of the workpiece, and determining the tangent to the workpiece at the apex.

The portion of the of the surface of the workpiece may correspond to the field of view of the camera.

In one example the method comprises providing the determined relative position as an input to a tool speed controller, wherein the tool speed controller is configured to:
compare the determined relative position of the tool to a second predetermined value, or to a second range of predetermined values, and:
if the determined relative position of the tool is greater than the second predetermined value, or is not within the second range of predetermined values, issue a speed control signal comprising an instruction to move the tool towards the new position at a first rate of change of relative position; or
if the determined relative position of the tool is less than or equal to the second predetermined value, or is within the second range of predetermined values, issue a speed control signal comprising an instruction to move the tool towards the new position at a second rate of change of relative position, wherein the second rate of change of relative position is less than the first rate of change of relative position,
wherein the tool position controller is configured to use the speed control signal to determine the motor control signal.

This method is advantageous as it allows a relatively quick approach of the tool towards the workpiece when the tool is located away from the workpiece, and slower movement of the tool when it is closer to the workpiece. This allows for finer motion control at close quarters without loss of overall process speed.

Optionally the tool speed controller is integral with the relative tool position controller.

The method optionally comprises repeating the method until the determined relative position of the tool is equal to the predetermined value or is within the range of predetermined values.

The method may comprise determining the relative position of the tool with respect to the workpiece at a predetermined frequency.

In one example the projector is a laser projector.

Optionally the camera is a digital camera and the detected image is converted into a computer readable format.

The method optionally comprises:
determining the magnitude of a force vector applied to the workpiece by the tool;
providing the determined magnitude of the force vector as an input to a force controller, wherein the force controller is configured to:
compare the determined magnitude of the force vector to a predetermined value, or to a range of predetermined values; and
if the determined magnitude of the force vector is not equal to the predetermined value, or is not within the range of predetermined values, issue a force control signal, wherein the force control signal comprises an instruction to bring the magnitude of the force closer to the predetermined value, or to the range of predetermined values;
or if the determined magnitude of the force vector is equal to the predetermined value, or is within the range of predetermined values, issue a force control signal, wherein the force control signal comprises an instruction to maintain the tool in its current relative position,
wherein the tool position controller is configured to use the force control signal to determine the motor control signal.

This method is advantageous as it prevent the tool applying too much force to the workpiece during operation thereby potentially damaging the workpiece.

The force controller may be integral with the relative tool position controller.

In one example the method comprises repeating the method until the determined magnitude of the force vector is equal to the predetermined value or is within the range of predetermined values.

Optionally the method comprises determining the magnitude of the force vector at a predetermined frequency.

The tool position controller is optionally configured to prohibit movement of the tool towards the workpiece if the determined magnitude of the force vector is greater than or equal to a predetermined maximum.

Determining the magnitude of the force vector may comprise determining the sum of force vectors applied to the tool by the motors.

In one example determining the magnitude of the force vector comprises obtaining a force measurement from a force sensor located between the tool and the robotic arm.

In another aspect, the present invention comprises a robotic arm comprising:
a tool mounted on the robotic arm;
a plurality of motors configured to manipulate the robotic arm and/or the tool;
a projector mounted on the tool or on the robotic arm;
a camera mounted on the tool or on the robotic arm; and
means adapted to execute the steps of the method described above.

Optionally the robotic arm comprises a force sensor located between the tool and the robotic arm and means adapted to execute the steps of the method described above.

The tool optionally comprises a non-destructive testing device, a coating applicator, an abrasive tool, or a polishing tool.

In a further aspect, the present invention provides a computer program comprising instructions to cause the robotic arm to execute the method steps described above.

In yet another aspect the present invention provides a computer-readable medium having stored thereon the computer program described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described, by way of example only, with reference to the accompanying drawings, in which:

FIG. 1 shows a schematic view of a wind turbine;

FIG. 2 shows a schematic view of a wind turbine blade;

FIG. 3 shows a schematic view of a cross-section through a wind turbine blade;

FIG. 4 shows a schematic view of a tool held by a robotic arm proximate a wind turbine blade;

FIG. 5 shows a schematic view of a tool suitable for use with the present invention;

FIG. 6 shows a schematic view of a laser line projection onto the wind turbine blade of FIG. 4;

FIG. 7 shows a cross-sectional view of the wind turbine blade of FIG. 4;

FIG. 8 shows a cross-sectional view of the wind turbine blade of FIG. 4 with a schematic representation of the robot arm holding the tool proximate the wind turbine blade;

FIG. 9 shows a schematic of a control system for a robotic arm; and

FIG. 10 shows a schematic of a system architecture suitable for implementing the control system of FIG. 9.

### DETAILED DESCRIPTION

The following detailed description refers to the accompanying drawings that show, by way of illustration, specific details and embodiments in which the invention may be practiced. These embodiments are described in sufficient detail to enable those of ordinary skill in the art to practice the invention. Other embodiments may be utilised, and structural changes may be made without departing from the scope of the invention as defined in the appended claims.

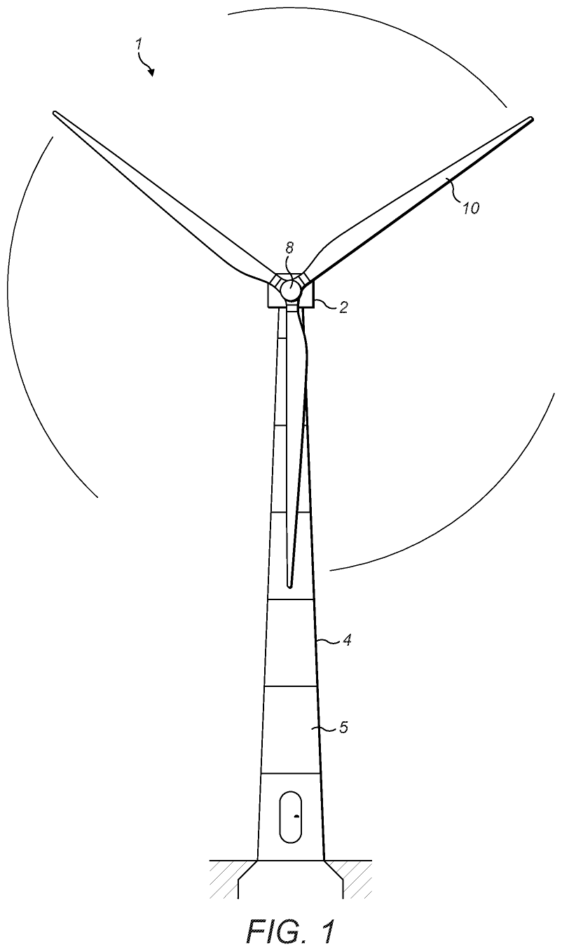

FIG. 1 shows a wind turbine 1. The wind turbine 1 includes a nacelle 2 that is supported on a generally vertical tower 4, which itself comprises a plurality of tower sections 5. The nacelle 2 houses a number of functional components, including a gearbox and a generator (not shown), and supports a main rotor arrangement 6. The main rotor arrangement 6 comprises a hub 8 and a plurality of wind turbine blades 10 connected to the hub 8. In this example, the wind turbine 1 comprises three wind turbine blades 10.

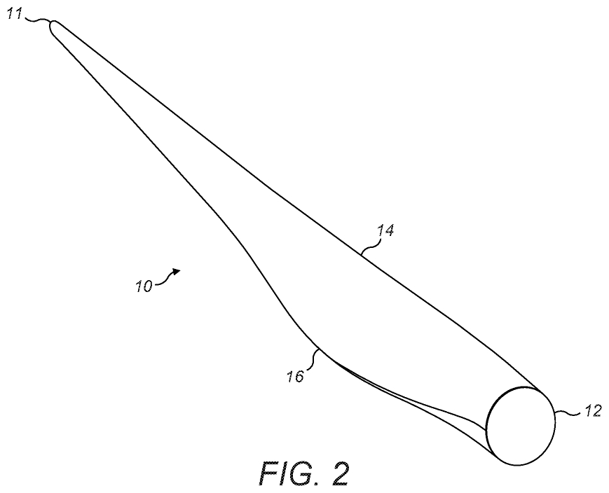

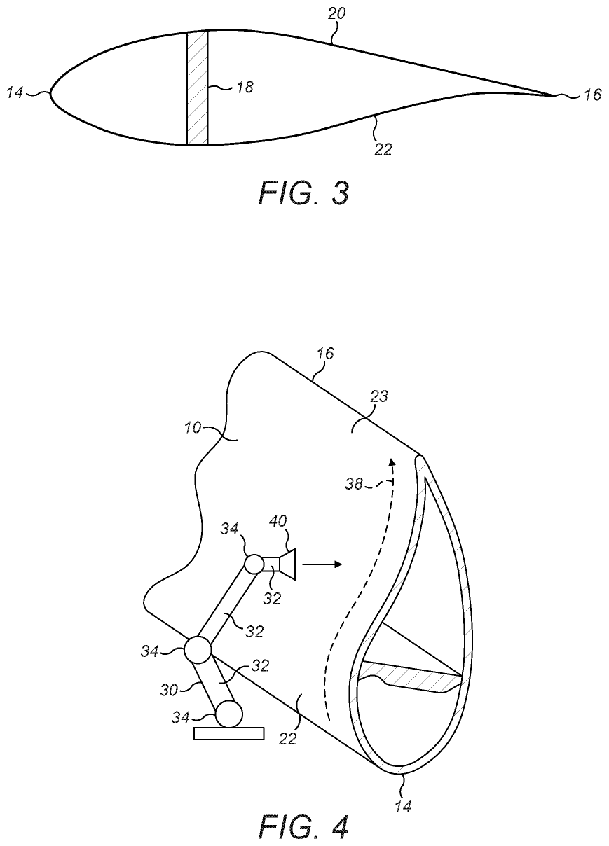

FIG. 2 shows a schematic isometric view of a wind turbine 10 and FIG. 3 shows a cross-section through the wind turbine 10. The wind turbine comprises a root end 12 and a tip end 11. The root end 12 is configured for attachment to the hub 8. A leading edge 14 and a trailing edge 16 extend between the root end 12 and the tip end 14. A leeward fairing 20 extends from the leading edge 14 to the trailing edge 16 on the leeward side of the blade 10, and a windward fairing 22 extends from the leading edge 14 to the trailing edge 16 on the windward side of the blade 10. A structural spar 18 which extends along the majority of the blade length is located between leeward fairing 20 and the windward fairing 22.

Modern wind turbine blades such as the wind turbine blade 10 shown in FIGS. 1 to 3 have an aerofoil shape in order to increase efficiency and reduce drag. The aerofoil shape of the wind turbine blade 10 results in highly complex blade geometry, with no similar cross-sectional shape existing from root 12 to tip 14 along the length of the blade. As discussed above, this, together with the great length of modern wind turbine blades, presents a problem for automation of manufacture and testing processes as it is difficult to reliably and repeatably position successive wind turbine blades 10 in precisely the same position and orientation during each manufacturing or testing process. Process automation relies on fixed computer inputs and machine pathing to guide automated systems. Therefore, if the workpiece (wind turbine blade in this case) is not positioned in exactly the correct position, it is possible that the automated process will fail to achieve the intended result. In a worst-case scenario, the wind turbine blade 10 may be damaged during the automated process if any part of the automated system unintentionally comes into contact with the wind turbine blade 10, or if too much force is applied to the wind turbine blade 10. Examples of manufacturing processes which can benefit from automation are sanding and painting operations.

It is not only manufacturing operations that benefit from automation. Testing operations such as non-destructive ultrasonic testing also benefit from automation if the parameters of the test equipment can be reliably set-up and repeated by the automated system. Ultrasonic testing is commonly used in wind turbine manufacture to detect any voids in the adhesive connection between the spar 18 and the inner surfaces of the leeward and windward fairings 20, 22. For the results of the ultrasonic testing to be reliable, it is critical that the ultrasonic testing tool is positioned normal to the surface of the wind turbine blade 10 at every point at which a reading is to be taken.

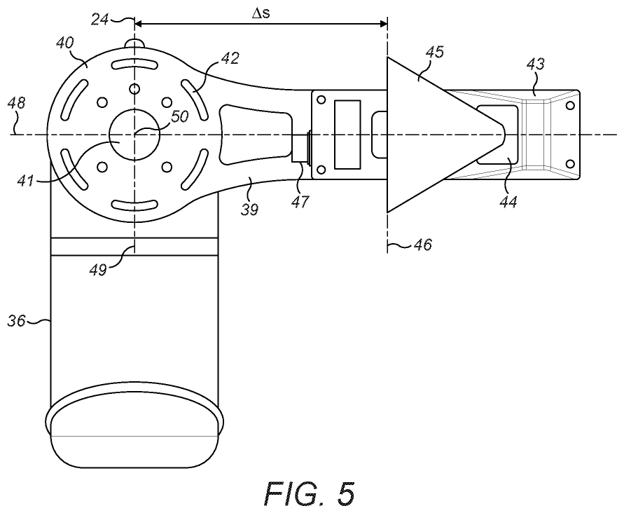

FIG. 4 shows a schematic view of a portion of a wind turbine blade 10 during an automated ultrasonic non-destructive testing process in which a robotic arm 30 supports an ultrasonic non-destructive testing tool 40 next to an outer surface 23 of the windward fairing 22 of the wind turbine blade 10. The robotic arm 30 comprises a plurality of substantially rigid links 32 which are connected at moveable joints 34 so that the links 32 may move relative to one another to position the tool 40 in a test position next to the outer surface 23 of the windward fairing 22. The tool 40 is mounted to a bracket 36 (see FIG. 5) located at the unsupported end of the robotic arm 30. The bracket 36 is connected to the robotic arm 30 by a joint 34 to allow for fine positioning of the tool next to the outer surface 23 of the wind turbine blade 10.

As will be understood by those skilled in the art of process automation, the robotic arm 30 may be mounted on a moveable support (not shown) such that it is moveable with respect to the wind turbine blade 10. In addition, it will be understood that the rigid links 32 may be telescopic such that they can change in length, and that the joints 34 may be configured to allow the rigid links 32 to move in all rotational degrees of freedom with respect to one another. The rigid links 32 and joints 34 of the robotic arm are actuated by electric motors (not shown) which are controlled by one or more motor controllers.

It will be understood that the robotic arm 30 may be configured to position the tool 40 next to any outer surface of the wind turbine blade 10 and that the placement of the tool next to the outer surface 23 of the windward fairing 22 as shown in FIG. 4 is by way of example only.

FIG. 5 shows the tool 40 mounted on the bracket 36. The tool 40 is an ultrasonic non-destructive test tool comprising an ultrasonic emitter 41 surrounded by a plurality of ultrasonic receivers 42. The tool 40 is connected to a signal processor which is configured to compile the data obtained by the tool 40 into a form which may be automatically or manually interpreted.

As is well known in the art of ultrasonic non-destructive testing, it is critical that the tool 40 is precisely positioned with respect to the surface of the workpiece to be tested. In this case, the surface of the workpiece is the outer surface 23 of the wind turbine 10. In order to ensure reliable data collection, it is imperative that the precise distance and orientation of the tool 40 with respect to the workpiece is correct. In particular, it is critical for the ultrasonic sound waves emitted by the ultrasonic emitter 41 to enter the surface of the workpiece in a direction normal to the surface of the workpiece. This ensures symmetrical penetration of the soundwaves into the workpiece. In view of the fact that ultrasonic non-destructive testing relies on the time difference between emission of the sound waves into the workpiece and receipt of sound waves reflected back by the internal structure of the workpiece, it is clear that symmetrical propagation of the soundwaves into the workpiece is critical to the accuracy of the data collected.

The ultrasonic emitter 41 is located at the tool origin 50 which coincides with the robot tool origin defined by a cartesian co-ordinate system 24 having an x-axis 48 and a y-axis 49. The tool 40 comprises a tool arm 39 which extends along the x-axis 48 away from the tool centre 50. A guidance apparatus 43 comprising a laser projector 44 and a digital camera 47 is mounted on the tool arm 39. The laser projector 44 is configured to project a plane of laser light 45 towards the tool origin 50 so that a laser line 46 is projected onto the workpiece in use. The camera 47 is configured to detect the laser line 46 and to convey the size and shape of the detected laser line 46 as an input to a tool position control system.

Referring once again to FIG. 4, in use, the robotic arm 30 moves the tool 40 along a toolpath 38 which extends from the leading edge side of the wind turbine blade 10 towards the trailing edge side of the wind turbine blade 10 and vice versa. As the robotic arm 30 moves the tool 40 along the path 38 the tool 40 scans a strip of the wind turbine blade 10. Once the tool 40 has been moved along the path 38, the robotic arm 30 moves the tool 40 in a spanwise direction of the wind turbine blade 10 so that an adjacent strip of the wind turbine blade 10 can be scanned. In this way the entire surface of the wind turbine blade 10, or specific sections of it, may be scanned by the tool 40. In order to optimise efficiency of tool movement, the tool 40 travels along the path 38 in one direction (for example from leading edge 14 to trailing edge 16) on one pass of the tool 40, and travels along the path 38 in the opposite direction (for example from trailing edge 16 to leading edge 14) in the subsequent pass. This is repeated until the desired scan area is covered by the tool 40.

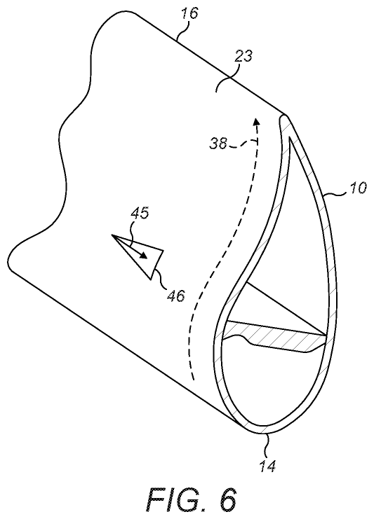

FIG. 6 shows a schematic view of the plane of laser light 45 creating the laser line 46 on the surface 23 the wind turbine blade 10. The robotic arm 30 and tool 40 have been omitted from this view for clarity. It can be seen from FIG. 6 that the plane of laser light 45 is projected in a direction which is perpendicular to the direction of the tool path 38.

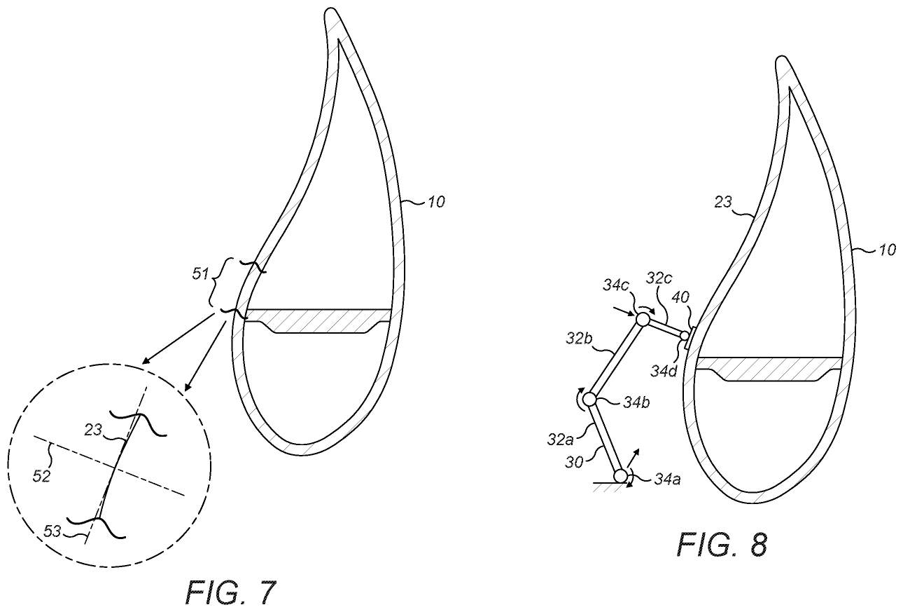

As depicted in FIG. 7, the camera 47 has a defined field of view 51 which is shown in magnified view in the detail of FIG. 7. As discussed above, the outer surface 23 of the wind turbine blade 10 comprises many complex curves. This is illustrated in FIG. 7 by the convex curve of the outer surface 23 at a tool location along the path 38 corresponding to the field of view 51. As discussed above, in order to get accurate and reliable readings from the non-destructive ultrasonic test tool 40, it is critical that the tool 40 be orientated such that the ultrasonic sound waves enter the surface of the workpiece in a direction normal to the surface of the workpiece. In the case of a convex curved surface such as that shown in FIG. 7, the ultrasonic sound waves must enter the workpiece in a direction parallel to the normal 52 of the tangent 53 to the surface 23 of the wind turbine blade 10. Therefore, referring to FIG. 5, in practice the z-axis (not shown) which is normal to the x-axis 48 and y-axis 49 of the robot cartesian co-ordinate system 24 must be parallel to the normal 52 of the surface 23 in order for high integrity data to be obtained by the tool 40 as it passes over the surface 23.

The projection of the laser line 46 onto the surface 23 of the wind turbine 10 is used to determine the position and orientation of the tool 40 with respect to the surface 23. In one example, the distance of the tool 40 from the surface 23 may be determined by using the camera 47 to detect the laser line 46 on the surface 23 and converting the detected image into a computer readable format. In one method, the number of pixels occupied by the laser line 46 in the detected image may be used to determine the distance of the camera 47 from the laser line 46. This may be done by the use of a look-up table or by direct calculation or any other suitable method as known to a person in the art. Because the distance of the laser projector with respect to the tool centre 50 is known, the distance of the tool centre 50 from the surface 23 of the wind turbine blade 10 along the z-axis of the robot cartesian co-ordinate system 24 can be calculated. Other methods of determining the distance of the tool 40 from the surface 23 from the image data collected by the camera 47 are also known in the art and may be used without prejudice in place of the pixel method of distance determination described above.

As mentioned above, the projection of the laser line 46 onto the surface 23 is also used to determine the orientation of the tool 40 with respect to the surface 23. In one example, the image data collected by the camera 47 is processed using methods known in the art to ascertain the tangent 53 to the surface 23 at a point intersecting the laser line 46 and the x-axis 48 of the robot co-ordinate system 24. In an alternative method, the image data collected by the camera 47 may be processed using methods known in the art to determine the location of the apex of the laser line 46, and the tangent 53 may then be determined at the apex. In a still further example, a combination of these methods may be used so that any disparity between the calculated tangent 53 at the intersection of the x-axis 48 and the laser line 46 may be compared with the calculation of the tangent 53 at the apex. An appropriate adjustment may then be made if needed. Other methods of determining the orientation of the tool 40 with respect to the surface 23 from the image data collected by the camera 47 may be used without prejudice in place of the methods described above.

Once the tangent 53 has been determined, the normal 52 to the surface 23 may be determined and the z-axis of the robot cartesian co-ordinate system 24 aligned with it. In one example, the control system (described below) may work on the assumption that the normal 52 to the surface 23 is the same at the tool centre 50 as it is at the laser line 46. Alternatively, the tangent 53 and normal 52 data may be stored and recalled for use at a later time. For example, data concerning the tangent 53 and normal 52 to the surface 23 may be determined and stored on one pass of the tool 40 over the surface 23 and then recalled for use on a subsequent pass of the tool 40 over the surface 23. Because the distance As between the tool centre 50 and the laser line projection 46 is known, the most appropriate tangent 53 and normal 52 measurements may be selected depending on the current location of the tool 40. This would be useful, for example, in circumstances in which the curvature, or other characteristic, of the surface is variable over the field of view 51 of the camera 47.

As mentioned above, it may be possible for the tool 40 to damage the surface 23 of the wind turbine blade if it applies too much pressure to the surface 23. In order to defend against this possibility, the robotic arm 30 may also be provided with a force sensor (not shown) located between the tool 40 and the robotic arm 30. The force sensor is configured to sense the resultant force vector applied to the surface 23 by the tool 40 as it passes over the surface 23.

An alternative method of ascertaining the force applied to the surface 23 by the tool 40 is illustrated in FIG. 8. In FIG. 8 the robotic arm 30 is shown comprising three rigid links 32a, 32b, 32c, 32d and four joints 34a, 34b, 34c, 34d. In order to ascertain the resultant force vector applied by the tool 40 to the surface 23, the sum of the moments applied to each joint 34a, 34b, 34c, 34d by the motors may be calculated. In one method known to those skilled in the art, a baseline measurement of motor amperage draw for all angles of the joints 34a, 34b, 34c, 34d is taken and a change calculation is carried out to calculate the force applied to the surface 23 by measuring motor loads during use at a high frequency rate.

It is known to control the path of robotic systems in automated process in a number of ways including: manual programming in which the automated machine motion is programmed using spatial coordinate assignments which reference robot joint positions relative to a known point in space; laser array scanning/computer tomography in which a point cloud is generated using advanced laser surface scanning and converted into an artificial part surface; CAD/CAM model based tool pathing; and on-board touch-teach where the robot is placed in idle mode and manually guided by a person to teach the robot the path to take. Each of these known methods have downsides in that they are either too rigid and therefore not suitable for use with wind turbine blades which are difficult to position accurately in space, or which are too time and labour intensive to be viable for use with a large structure such as a wind turbine blade. These problems can be overcome by the use of feedback received from the guidance apparatus 43.

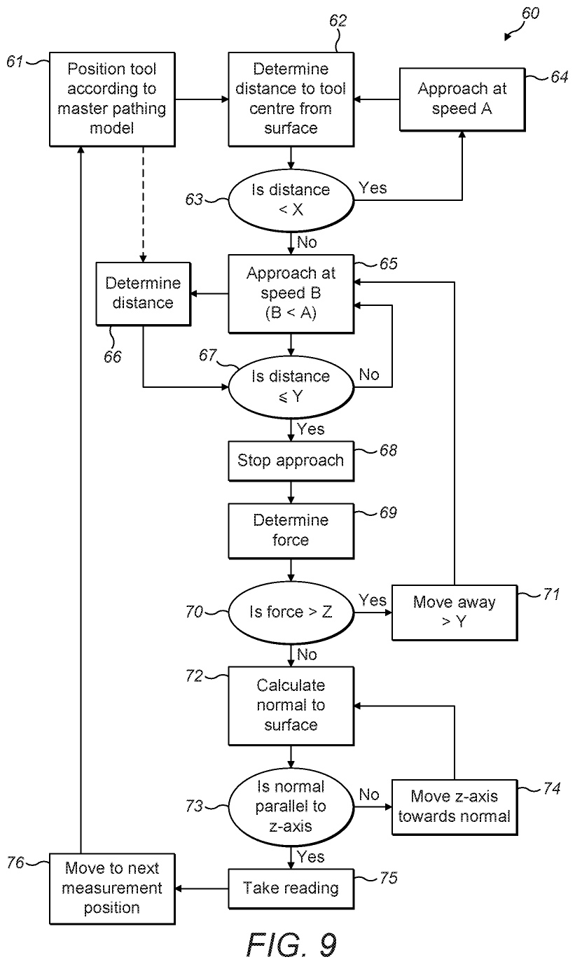

FIG. 9 shows a schematic flow diagram of a control system 60 suitable for use with the tool 40 and robotic arm 30 described above. At step 61 the tool 40 is positioned in accordance with a master pathing model which has been generated by one of the methods outlined above. The tool 40 is positioned with reference to the tool centre 50. At step 62 the distance of the tool 40 from the surface 23 is determined by use of the data generated by the camera 47 when it detects the laser line 46. If the distance of the tool 40 is greater that a predetermined distance X the tool 40 is moved towards the surface 23 at a speed A (the predetermined distance X may be referred to as a second predetermined distance). This is represented by steps 63 and 64. Alternatively, if the distance between the tool 40 and the surface 23 is less than X the tool 40 is moved towards the surface 23 at a speed B, where the speed B is less than the speed A. This is represented by steps 63 and 65.

Next, at step 66, the distance of the tool 40 from the surface 23 is determined. If the distance of the tool 40 is greater than a predetermined distance Y the tool 40 is moved towards the surface 23 at speed B. This is represented by steps 67 and 65. Alternatively, if the distance between the tool 40 and the surface 23 is less than or equal to Y the approach of the tool 40 is stopped. This is represented by steps 67 and 68.

At step 69 the magnitude and direction of the force applied to the surface 23 by the tool 40 is determined either directly by use of a force sensor, or indirectly by a summation of moments applied to the tool 40 by the motors which actuate the joints 34a, 34b, 34c, 34d of the robotic arm 30. If the force is greater than a predetermined force Z the tool 40 is moved away from the surface 23 by a distance greater than Y. This is represented by steps 70 and 71. The process then returns to step 65. Alternatively, if the force is less than or equal to Z the normal 52 to the surface 23 is calculated or retrieved from a store of pre-measured normals. This is represented by steps 70 and 72.

At step 73 a determination is made as to whether the z-axis of the robot cartesian co-ordinate system 24 is parallel to the normal 52. If it is not the orientation of the tool 40 is moved to bring the z-axis closer to parallel with the normal 52. This is represented by steps 73 and 74. This loop is repeated until the z-axis is parallel to the normal 52.

If/when the z-axis is parallel to the normal 52 the tool 40 is operated to take a reading at step 75. The tool 40 is then moved to the next position in accordance with the master pathing model as represented by steps 76 and 61. The process then repeats until the last point dictated by the master pathing model. If desired, the process can move from step 61 directly to step 66 on the second and subsequent iterations as illustrated by the dashed line in FIG. 9.

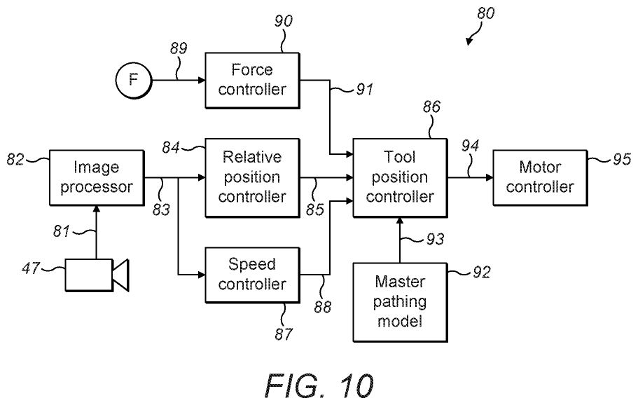

FIG. 10 shows a schematic diagram of an example system architecture 80 suitable for implementing the control system 60. In this example architecture 80, the camera 47 detects the laser line 46 on the surface 23 of the wind turbine blade 10 and provides an input signal 81 to an image processor 82 which is configured to determine one or more relative positions of the tool 40 with respect to the surface 23 using any suitable method as known to a person skilled in the art. The image processor 83 may be configured to determine the distance of the tool 40 from the surface 23, and/or the angle of the tool 40 with respect to the tangent 53 or normal 52 to the surface 23. The image processor 82 then provides the determined relative position(s) of the tool 40 as an input 83 to a relative position controller 84.

The relative position controller 84 is configured to issue a relative position control signal 85 in dependence on whether the determined relative position(s) of the tool 40 are greater or less than predetermined values or within predetermined ranges. The relative position control signal 85 is provided as an input to the tool position controller 86.

The image processor 82 may optionally provide the determined relative position(s) of the tool 40 as an input 83 to a tool speed controller 87. The tool speed controller 87 is configured to issue a speed control signal 88 in dependence on whether the determined relative distance of the tool 40 is greater or less than a predetermined value or within a predetermined range. The speed control signal 88 is provided as an input to the tool position controller 86.

Optionally a force reading 89 may be provided to a force controller 90. As discussed above, the force reading 89 may be obtained from a force sensor located between the tool 40 and the robotic arm 30, or the force reading may be calculated from a summation of the motor torques at each joint 34a, 34, 34c, 34d of the robotic arm 30. The force controller 90 is configured to issue a force control signal 91 in dependence on whether the measured or calculated force reading 89 is greater or less than a predetermined value or within a predetermined range. The force control signal 91 is provided as an input to the tool position controller 86.

A master pathing model 92 is used to provide a master control signal 93 as an input to the tool position controller 86 which is configured to determine a motor control signal 94 in dependence on the relative position control signal 85 and the master control signal 93 (and optionally also in dependence on the speed control signal 88 and/or force control signal 91).

The master control signal 93 and the relative position control signal 85 may be used to determine the motor control signal 94 by means of a prioritised superposition of the master control signal 93 and the relative position control signal 85 methods for which are well known to those skilled in the art.

The motor control signal 94 is provided as an input 94 to the one or more motor controllers 95 which control the motors to control the position of the tool 40 with respect to the surface 23 of the wind turbine blade 10.

It will be clear to a person skilled in the art that the example system architecture 80 is an example only and that many different system architectures may be used. In particular, any one or more of the image processor 82, relative position controller 84, tool speed controller 87, force controller 90, tool position controller 86, and motor controller 95 may be realised by one or more computer systems programmed to control the movement of the tool 40.

It is not essential that the laser projector 45 face towards the tool centre 50. In another embodiment (not shown) the laser 45 may face away from the tool centre. Similarly, it is not essential that the camera 47 and/or laser projector 45 be mounted on the tool 40. The camera 47 and/or the laser projector 45 may be mounted on the robot arm 30. Provided that the relative positions between the tool centre 50 and the laser projector 45 are known the necessary calculations can be made.

Light sources other than laser may be used to project an image on to the workpiece. Similarly, shapes other than single lines may be projected such as circles or rectilinear shapes.

As mentioned above, the method of tool control disclosed herein may be used to control tools other than non-destructive testing tools. Examples include coating applicators, sanders and polishers.

It will be clear to the skilled person that use of the described techniques are not limited to wind turbine blade testing and manufacture, or to composite part manufacture in general. The described techniques may be used in any application where it is desirable to automate processes requiring accurate positioning of a tool proximate a workpiece.

1. A method of controlling the position of a tool relative to a workpiece, wherein the tool is mounted on a robotic arm, and wherein the tool position is manipulable by a plurality of motors controlled by one or more motor controllers, the method comprising:
projecting an image onto the workpiece from a projector mounted on the tool or on the robotic arm, wherein the projected image comprises a line;
detecting the projected image using a camera mounted on the tool or on the robotic arm;
using the detected image to determine a relative position of the tool with respect to the workpiece; and
providing the determined relative position as an input to a relative position controller,
wherein the relative position controller is configured to:
compare the determined relative position of the tool to a predetermined value, or to a range of predetermined values; and
if the determined relative position of the tool is not equal to the predetermined value, or is not within the range of predetermined values, issue a relative position control signal to a tool position controller, wherein the relative position control signal comprises an instruction to move the tool to a new position in which the relative position of the tool is closer to the predetermined value, or closer to the range of predetermined values; or
if the determined relative position of the tool is equal to the predetermined value, or is within the range of predetermined values, issue a relative position control signal to the tool position controller, wherein the relative position control signal comprises an instruction to maintain the tool in its current relative position,
wherein the tool position controller is configured to use the relative position control signal to determine a motor control signal, and wherein the tool position controller is configured to issue the motor control signal to the one or more motor controllers.

2. A method as claimed in claim 1, comprising:
providing a computer readable master pathing model;
using the master pathing model to generate a master control signal;
providing the master control signal as an input to the tool position controller, wherein the tool position controller is configured to:
use the master control signal and the relative position control signal to determine the motor control signal.

3. A method as claimed in claim 2, wherein using the master control signal and the relative position control signal to determine the motor control signal comprises a prioritised superposition of the master control signal and the relative position control signal.

4. A method as claimed in claim 1, wherein using the detected image to determine a relative position of the tool with respect to the workpiece comprises determining a relative angular position between the tool and the workpiece, and wherein the step of issuing the relative position control signal comprises issuing a relative position control signal comprising an instruction to bring the relative angular position closer to the predetermined value, or to the range of predetermined values.

5. A method as claimed in claim 4, wherein using the detected image to determine a relative angular position of the tool with respect to the workpiece comprises determining a tangent to the workpiece.

6. A method as claimed in claim 1, wherein the relative position of the tool is determined relative to a specific feature of the tool.

7. A method as claimed in claim 5, wherein using the detected image to determine the tangent to the workpiece comprises determining the position of an apex of a portion of the surface of the workpiece, and determining the tangent to the workpiece at the apex.

8. A method as claimed in claim 7, wherein the portion the of the surface of the workpiece corresponds to the field of view of the camera.

9. A method as claimed in claim 1, comprising providing the determined relative position as an input to a tool speed controller, wherein the tool speed controller is configured to:
compare the determined relative position of the tool to a second predetermined value, or to a second range of predetermined values, and:
if the determined relative position of the tool is greater than the second predetermined value, or is not within the second range of predetermined values, issue a speed control signal comprising an instruction to move the tool towards the new position at a first rate of change of relative position; or
if the determined relative position of the tool is less than or equal to the second predetermined value, or is within the second range of predetermined values, issue a speed control signal comprising an instruction to move the tool towards the new position at a second rate of change of relative position, wherein the second rate of change of relative position is less than the first rate of change of relative position,
wherein the tool position controller is configured to use the speed control signal to determine the motor control signal.

10. A method as claimed in claim 9, wherein the tool speed controller is integral with the relative tool position controller.

11. A method as claimed in claim 1, comprising repeating the method until the determined relative position of the tool is equal to the predetermined value or is within the range of predetermined values.

12. A method as claimed in claim 1, comprising determining the relative position of the tool with respect to the workpiece at a predetermined frequency.

13. A method as claimed in claim 1, wherein the projector is a laser projector.

14. A method as claimed in claim 1, wherein the camera is a digital camera and wherein the detected image is converted into a computer readable format.

15. A method as claimed in claim 1, comprising:
determining the magnitude of a force vector applied to the workpiece by the tool;
providing the determined magnitude of the force vector as an input to a force controller, wherein the force controller is configured to:
compare the determined magnitude of the force vector to a predetermined value, or to a range of predetermined values; and
if the determined magnitude of the force vector is not equal to the predetermined value, or is not within the range of predetermined values, issue a force control signal, wherein the force control signal comprises an instruction to bring the magnitude of the force closer to the predetermined value, or to the range of predetermined values;
or if the determined magnitude of the force vector is equal to the predetermined value, or is within the range of predetermined values, issue a force control signal, wherein the force control signal comprises an instruction to maintain the tool in its current relative position,
wherein the tool position controller is configured to use the force control signal to determine the motor control signal.

16. A method as claimed in claim 15, wherein the force controller is integral with the relative tool position controller.

17. A method as claimed in claim 15, comprising repeating the method until the determined magnitude of the force vector is equal to the predetermined value or is within the range of predetermined values.

18. A method as claimed in claim 17, comprising determining the magnitude of the force vector at a predetermined frequency.

19. A method as claimed in claim 15, wherein the tool position controller is configured to prohibit movement of the tool towards the workpiece if the determined magnitude of the force vector is greater than or equal to a predetermined maximum.

20. A method as claimed in claim 15, wherein determining the magnitude of the force vector comprises determining the sum of force vectors applied to the tool by the motors.

21. A method as claimed in claim 15, wherein determining the magnitude of the force vector comprises obtaining a force measurement from a force sensor located between the tool and the robotic arm.

22. A robotic arm comprising:
a tool mounted on the robotic arm;
a plurality of motors configured to manipulate the robotic arm and/or the tool;
a projector mounted on the tool or on the robotic arm;
a camera mounted on the tool or on the robotic arm; and
a controller configured to perform an operation of controlling the position of the tool relative to a workpiece, the operation comprising:
projecting an image onto the workpiece from the projector, wherein the projected image comprises a line;
detecting the projected image using the camera;
using the detected image to determine a relative position of the tool with respect to the workpiece; and
providing the determined relative position as an input to a relative position controller, wherein the relative position controller is configured to:
compare the determined relative position of the tool to a predetermined value, or to a range of predetermined values; and
if the determined relative position of the tool is not equal to the predetermined value, or is not within the range of predetermined values, issue a relative position control signal to a tool position controller, wherein the relative position control signal comprises an instruction to move the tool to a new position in which the relative position of the tool is closer to the predetermined value, or closer to the range of predetermined values; or
if the determined relative position of the tool is equal to the predetermined value, or is within the range of predetermined values, issue a relative position control signal to the tool position controller, wherein the relative position control signal comprises an instruction to maintain the tool in its current relative position,
wherein the tool position controller is configured to use the relative position control signal to determine a motor control signal, and wherein the tool position controller is configured to issue the motor control signal to the one or more motor controllers.

23. A robotic arm as claimed in claim 22, further comprising a force sensor located between the tool and the robotic arm.

24. A robotic arm as claimed in claim 22, wherein the tool comprises a non-destructive testing device, a coating applicator, an abrasive tool, or a polishing tool.

25-27. (canceled)

28. A computer program comprising instructions which, when executed, cause a robotic arm to execute an operation controlling a position of a tool relative to a workpiece, wherein the tool is mounted on the robotic arm, and wherein the tool position is manipulable by a plurality of motors controlled by one or more motor controllers, the operation, comprising:
projecting an image onto the workpiece from a projector mounted on the tool or on the robotic arm, wherein the projected image comprises a line;
detecting the projected image using a camera mounted on the tool or on the robotic arm;
using the detected image to determine a relative position of the tool with respect to the workpiece; and
providing the determined relative position as an input to a relative position controller, wherein the relative position controller is configured to:
compare the determined relative position of the tool to a predetermined value, or to a range of predetermined values; and
if the determined relative position of the tool is not equal to the predetermined value, or is not within the range of predetermined values, issue a relative position control signal to a tool position controller, wherein the relative position control signal comprises an instruction to move the tool to a new position in which the relative position of the tool is closer to the predetermined value, or closer to the range of predetermined values; or
if the determined relative position of the tool is equal to the predetermined value, or is within the range of predetermined values, issue a relative position control signal to the tool position controller, wherein the relative position control signal comprises an instruction to maintain the tool in its current relative position,
wherein the tool position controller is configured to use the relative position control signal to determine a motor control signal, and wherein the tool position controller is configured to issue the motor control signal to the one or more motor controllers.

29. A computer program as claimed in claim 28, further comprising a force sensor located between the tool and the robotic arm and wherein the operation further comprises determining a magnitude of the force vector by obtaining a force measurement from the force sensor.

30. A method of controlling the position of a tool relative to a workpiece, wherein the tool is mounted on a robotic arm, and wherein the tool position is manipulable by a plurality of motors controlled by one or more motor controllers, the method comprising:
projecting a image onto the workpiece from a projector, wherein the image comprises a line;
detecting the image using a camera;
using the image to determine a first relative position of the tool with respect to the workpiece; and
providing the first relative position as an input to a relative position controller, wherein the relative position controller is configured to:
compare the first relative position of the tool to a predetermined value or a range of predetermined values; and
upon determining that the first relative position of the tool is not equal to the predetermined value, or is not within the range of predetermined values, issue a first relative position control signal to a tool position controller, wherein the first position control signal comprises an instruction to move the tool to a new position in which the relative position of the tool is closer to the predetermined value, or closer to the range of predetermined values;
wherein the tool position controller is configured to use the first relative position control signal to determine a first motor control signal, and wherein the tool position controller is configured to issue the first motor control signal to the one or more motor controllers.

31. A method as claimed in claim 30, further comprising:
using the image to determine a second relative position of the tool with respect to the workpiece; and
providing the second relative position as an input to a relative position controller, wherein the relative position controller is configured to:
compare the second relative position of the tool to the predetermined value or the range of predetermined values; and
upon determining that the second relative position is equal to the predetermined value, or is within the range of predetermined values, issue a second relative position control signal to the tool position controller, wherein the second relative position control signal comprises an instruction to maintain the tool in its current relative position;
wherein the tool position controller is configured to use the second relative position control signal to determine a second motor control signal, and wherein the tool position controller is configured to issue the second motor control signal to the one or more motor controllers.
